(19) United States
(12) Patent Application Publication
(10) Pub. No.: US 2008/0142603 A1
(43) Pub. Date: Jun. 19, 2008

(54) Portable Industrial Data Capturing Device

(76) Inventor: Gerhard Stephanus Mynhardt, Sandton (ZA)

Correspondence Address: FROMMER LAWRENCE & HAUG, 745 FIFTH AVENUE- 10TH FL., NEW YORK, NY, 10151, US

(21) Appl. No.: 11/933,487

(22) Filed: Nov. 1, 2007

(30) Foreign Application Priority Data
Nov. 1, 2006 (ZA) 2006/09107

(51) Int. Cl. G06K 7/10

(52) U.S. Cl. 235/462.43

(57) ABSTRACT

A portable data capturing device including an upper housing including a display on one side thereof and a lower housing, the housings being mechanically connected together with a hinge arrangement in such a way so as to allow the two housings to be moved between an open position and first and second closed positions, wherein in the first closed position the display is not visible to a user of the device but in the second closed position the display is visible to a user of the device. A flexible electrical signal connection extends between the two separate housings. Also included in the housings are processing means with program and data storage memory, a keypad, a barcode reader, at least one battery to power the device and a communications interface to allow the device to communicate with another device. Furthermore, the device may include an RFID reader integrated into one of the two housings. The upper housing is able to rotate about a first axis from the first closed position into the open position and wherein when in the open position the upper housing can be rotated about a second axis with respect to the lower housing thereby changing the direction that the display faces, and wherein the upper housing can then be rotated about the first axis into the second closed position.

This application claims priority to South African Patent Application No. 2006/09107 filed Nov. 1, 2006, the disclosure of which is hereby incorporated by reference.

### FIELD OF THE APPLICATION

The field of the disclosed invention comprises portable industrial data scanning and collecting devices, and in an example embodiment to a data capturing device that may comprise at least one of a barcode reader and an RFID reader, as well as a keypad and display.

### BACKGROUND OF THE INVENTION

It is common to use portable industrial data scanning and collecting devices or terminals comprising a display, a processor, a keypad, a barcode reader and often an RFID reader, for a variety of logistics, data capturing, inventory management, and other activities. Such portable data collecting terminals often have a conflicting requirement, which is to be compact enough to be accommodated in a user's pocket, for example, while having a display as large as possible, a keypad with an adequate number of keys, a barcode scanner, an RFID reader option, replaceable battery, and extensive integral communications resources. For these components to be accommodated in a design compact enough to be accommodated in a user's pocket presents conflicting requirements, which do not appear to have been fully addressed to date.

Current portable industrial data capturing terminals have a large footprint due to its display, with a keypad being fixed on a top side of the device. However, there is still a need for a truly pocket-size, fully functioning, portable industrial data capturing device.

### SUMMARY OF THE INVENTION

In broad terms, the current invention provides a pocket-size portable industrial data capturing device, which comprises either or both a barcode reader and an RFID reader, a display and a keypad, with these components being arranged into two housings that are tightly and mechanically connected with a swivel and rotate hinge arrangement and electrically connected with cables that can extend through the hinge arrangement.

This arrangement allows the device to be closed into a compact form for carrying around in a pocket (for example, a shirt pocket), to be opened for full exposure of the display and keypad when needed for active scanning, and, in one embodiment, for the display to be swiveled up and rotated around, then folded down to define a compact unit that can be used for scanning and other operations but with the full keypad not being required for data entry.

In an example embodiment therefore, there is provided a portable data capturing device comprising:
an upper housing including a display on one side thereof and a lower housing, the housings being mechanically connected together with a hinge arrangement in such a way so as to allow the two housings to be moved between an open position and first and second closed positions, wherein in the first closed position the display is not visible to a user of the device but in the second closed position the display is visible to a user of the device;
a flexible electrical signal connection extending between the two separate housings;
processing means with program and data storage memory;
a keypad;
a barcode reader;
at least one battery to power the device; and
a communications interface to allow the device to communicate with another device.

### BRIEF DESCRIPTION OF THE DRAWINGS

FIG. 1 shows a top perspective view of a portable industrial data capturing device, according to an example embodiment, the device being shown in a closed position;

FIG. 2 shows a top perspective view of the portable industrial data capturing device in a first opened position;

FIG. 3 shows a top perspective view of the portable industrial data capturing device in a second closed position;

FIG. 4 shows a top perspective view of a swivel and rotate hinge arrangement, according to an example embodiment, which may be used by the data capturing device;

FIG. 5 shows a top perspective view of an upper housing of the data capturing device being rotated around an axis so as to move between its open and second closed positions;

FIG. 6 shows a bottom perspective view of the portable industrial data capturing device in its closed position, showing the removable battery and processor module of the device;

FIG. 7 shows a schematic diagram of an electronic circuit that may be used in the data capturing device; and

FIG. 8 shows a top view of the portable industrial data capturing device in its first opened position, showing a functional key section and a data entry section.

### DESCRIPTION OF PREFERRED EMBODIMENTS

Referring to the drawings, a pocket-size portable industrial data capturing device, according to an example embodiment, may comprise the following functional modules:

1. An upper and lower housing, mechanically tightly connected together with a swivel and rotate hinge arrangement (201), comprising a variety of electronic modules that may be electrically interconnected with flexible cables, as shown in FIG. 2.

2. A display 200 (for example, a 2.5″ graphics LCD display) mounted on one side of the upper housing. In an example embodiment, the display 200 may comprise a touch screen. The hinge arrangement allows the two housings to be moved between an open position and first and second closed positions, wherein in the first closed position the display is not visible to a user of the device but in the second closed position the display is visible to a user of the device.

3. A keypad 202 (for example, a 19 key keypad) comprising numeric and functional keys located in the lower housing.

4. Processing means in the form of a processor module 602 (for example, based on an ARM 32 bit processor) with program memory and data storage memory. The processor module 602 may also include a communications interface in the form of an externally available RS232 serial interface as well as a power supply to allow the device to communicate with another device.

5. At least one battery 601, for example a single 9V permanent battery to power the device. In an example embodiment, the battery may comprise a replaceable Energizer X22 alkaline battery, which may be housed in the bottom housing.

6. A barcode reader including a barcode reader engine 501 that may be mounted in the bottom housing.

7. An optional RFID reader 704. In an example embodiment, this reader 704 comprises a 13.56 MHz ISO15693 RFID reader with a read coil mounted in the upper housing (for example, around the display 200).

8. An enclosure to house the upper part that may comprise mainly the display 200 and the optional RFID reader coil, and to house the bottom part that may comprise mainly the keypad 202, the processor circuitry 602, the battery 601, the barcode reader and/or the RFID reader circuitry, and to allow the device to interface to external host computers.

9. A swivel and rotate hinge arrangement 204 to connect the top and bottom enclosure housings, with the cables connecting the display to the processor being routed through a hollow part of the hinge arrangement. The cables are in the form of a flexible electrical signal connection extending between the two separate housings.

It will be appreciated that each of the processing means, display, keypad, barcode reader, at least one battery and the communications interface are located in one of the two housings.

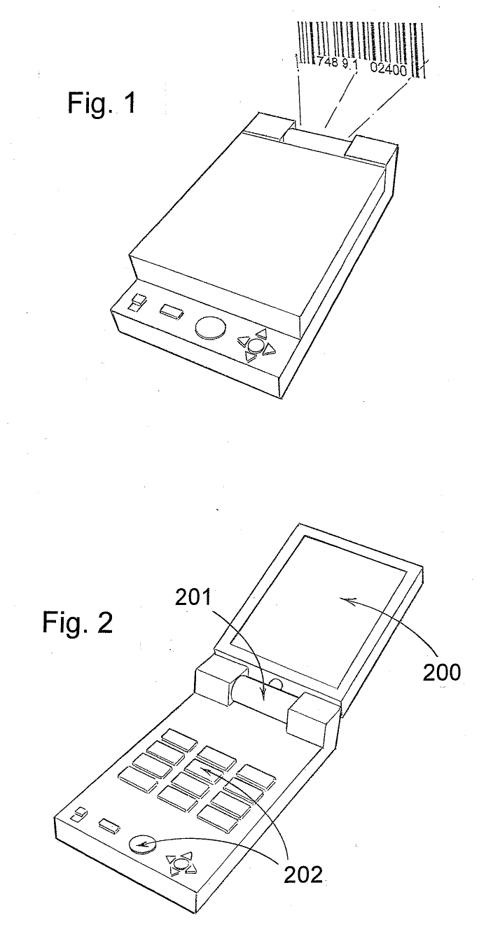

The closed position shown in FIG. 1 will be used as a starting point. In its closed position, the top housing comprising the display 200 is fully pressed down, with the display facing inwards towards the keypad 202, with the covered part of the top housing now being at the top. In an example embodiment, the functional key section of the keypad may remain exposed and available to the user to, for example, scan in barcodes, as shown in FIG. 1.

Turning now to FIG. 2, the upper housing may be lifted up by swiveling it straight backwards, thereby exposing the display 200, as well as the data entry section of the keypad 202. The display may be swiveled back to substantially any angle, including to nearly 180 degrees backwards, if required, as shown in FIG. 2.

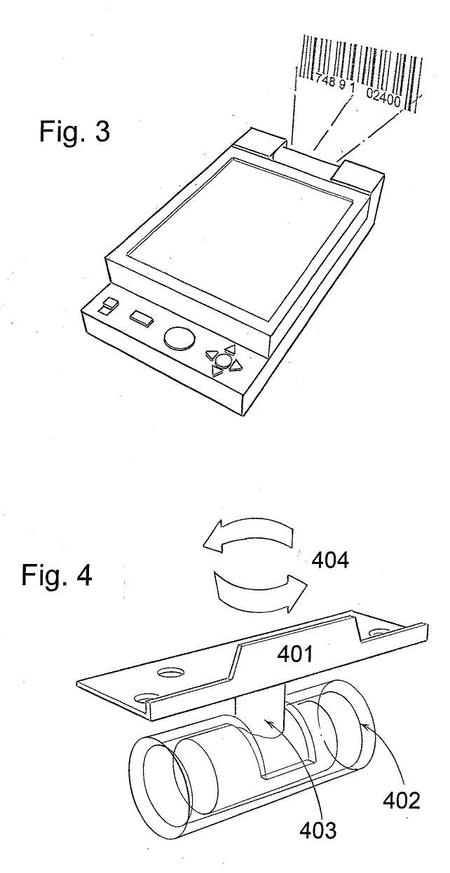

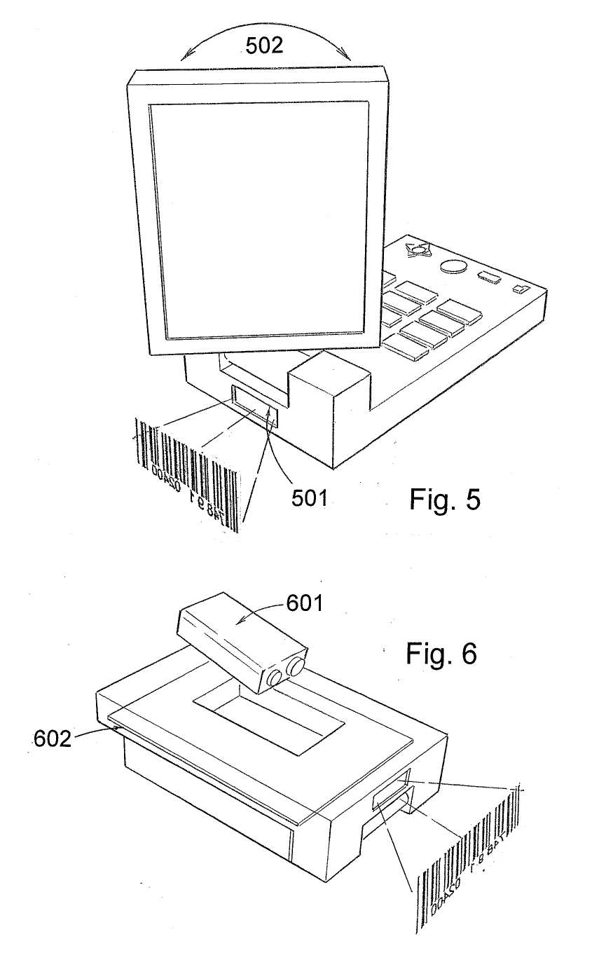

In the first opened position shown in FIG. 2, the display 200 may be rotated completely through 180 degrees, so that the display is pointing away from the keypad 202, as shown in FIG. 5. The top display housing may then be pushed down to the point where the device is again fully closed, but the display is now pointing upwards so as to define a second closed position. In this position, the display 200 is completely visible to the user, but the data entry section of the keypad is now totally closed, as shown in FIG. 3. In this second closed position, the device is able to scan, for example, barcodes, as shown.

In an example embodiment, the bottom housing may be no more than 65 mm wide, approximately 18 mm high, with a length of 110 mm. These dimensions allow the device to rest comfortably in even small hands supporting the device from below. The section may be flat at the bottom to allow the device to rest on a flat surface; however, it may alternatively be rounded for a better fit in a user's hand. In an example embodiment, the bottom housing may accommodate the battery 601, keypad 202, processor 602 and related circuitry, as shown in FIG. 6.

In an example embodiment, the upper housing may be approximately 65 mm wide, have a length of 75 mm, with a height of 10 mm.

The complete housing for the device may be injection moulded, using a plastic material such as ABS, or it may be cast in a magnesium alloy material.

Turning now to FIG. 4, a swivel and rotate (so as to define 2 axes) hinge arrangement may be used, which is sometimes referred to in the art as a nail-cutter hinge. This hinge firmly connects the two individual housings together to form one coherent compact unit. The hinge provides dual axis movements. The display housing is attached to the flat part of the hinge 401, with the main body of the hinge 402 being fixed to the lower housing.

Thus the upper housing can rotate about a first axis from the first closed position into the open position and wherein when in the open position the upper housing can be rotated about a second axis with respect to the lower housing thereby changing the direction that the display faces, and wherein the upper housing can then be rotated about the first axis into the second closed position.

A hollow tube 403 may be used to connect the flat part and the base of the hinge, allowing flexible cables to be inserted into the tube 403 to connect the various circuits which make up the complete scanning pocket-size data capturing device. This tube 403 may be attached to a nylon or spring loaded round section which can rotate inside the tubular round main body of the hinge 402. Simultaneously, the upper section flat part 401 may independently rotate in a different axis movement, indicated by arrows 404. This arrangement, therefore, allows the upper housing to be rotated around its center axis, while, being independently being able to be flipped up away from the bottom housing, all the while remaining tightly connected.

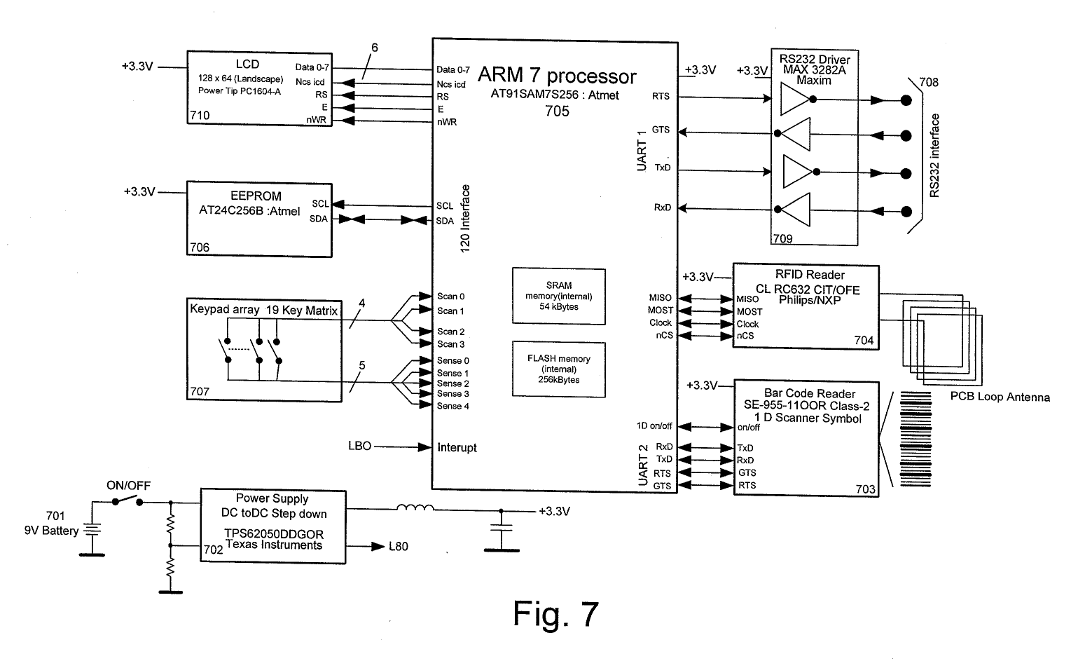

FIG. 7 shows a schematic circuit diagram for an electronic implementation of the disclosed data capturing device, according to an example embodiment. A single processor module 602 may be used, comprising all the electronic circuitry, the keypad switches, the optional RFID circuitry, and also the barcode reader module.

In an example embodiment, 9V DC power (for example, from an Energizer X22 alkaline battery 701) may be applied via a slide on/off switch, and connected to a TPS62050 power supply module, which can provide a regulated 3.3V output to the circuitry. Additionally, this power supply controller may also provide a battery low output LBO signal, 702, to the processor, resulting in a message on the screen to users when the battery voltage goes low, indicating that the battery should be replaced.

The processor module 602 may comprise a 32 bit ARM7 processor AT92SAM7S256 from Atmel, indicated by numeral 705. This processor has 256 kbytes of integral flash memory, used mainly for program and captured data storage, as well as 64 kbytes of integrated SRAM, used for temporary data storage. Read/write SRAM memory (RAM) may be required to store dynamically changing data, pointers, stack etc.

The software program contained in the ARM7 processor will typically be developed in C language, and will execute a number of steps, typically to drive the display, sense the keypad, enable and read the barcode reader and/or the RFID reader, store the read data in the external serial flash memory, and then finally upload this stored data via the RS232 serial port when connected to a host computer. Development of this software is relatively straightforward to those skilled in the art.

Captured data may be stored in an external Atmel AT24C256B EEPROM flash memory module 706. The interface may be via a 12C serially clocked 2 wire interface. This memory module 706 can store 32 kbytes of captured scanned barcode, keyed in data and RFID data. After uploading of data to the relevant host computer, this memory may be cleared again.

The ARM7 processor 705 may comprise integrated data I/O ports, one of which may be used to drive the display 710. The display 710 may comprise a 128 pixel by 64 pixel PowerTip PC1604-a graphics display that may allow text and graphics pictures to be displayed under program control. The standard 8 bit LCD interface is used via Data 0-7, where 8 bit commands and 8 bit pixel data is transferred direct to the LCD by issuing the 8 bit data, then driving an E clock signal, the nCS_lcd signal, and taking an nWR signal momentarily low to latch the data into the LCD. An RS signal indicates whether the data supplied to the LCD is either commands (low) or data (high).

In an example embodiment, the data capturing device may use an OEM SE-955-110OR barcode scanning module from Symbol Technologies. This barcode scanning module may start scanning when it receives a trigger command, with it then returning the decoded barcode data to the attached host processor via the serial data interface. This OEM module scans and decodes linear barcodes, such as Code 3 of 9, Interleaved 2 of 5, EAN, UPC, Code 128 etc, and provides the complete decoded data output to the processor 705. The processor 705 stops scanning under program control. The ARM7 processor 705 may interface to the serial data lines via its internal serial UART2 interface port.

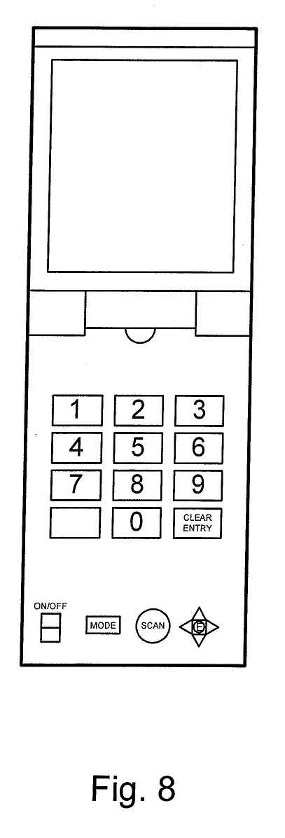

The 19 key keypad array may be interrogated by 4 scan and 5 sense I/O peripheral signals integrated into the ARM processor 705, and may be arranged to signal to the application software when a key is pressed. As shown in FIG. 8, one key may be dedicated to trigger scanning (SCAN), with this causing either a barcode scan or an RFID read.

As indicated above, the keypad, as shown in FIG. 2, may comprise 2 sections, a function key section, and a data entry section. In an example embodiment, the function key section may always be available, while the data entry section may only be available in the first opened position shown in FIG. 2. Therefore, the keypad section may be covered in the first and second positions.

The function key section, as shown in FIG. 8, may comprise a total of 7 key buttons plus a miniature power on/off slide switch. These key buttons may comprise 4 directional navigational keys, an ENTER key, the SCAN key and a MODE key. An important functional aspect of this arrangement is that the disclosed portable data capturing device can, in many cases, be operated with just these function keys. The data entry section may comprise 12 keys, being the 0 to 9 numeric buttons, a decimal point button, and a CLEAR ENTRY button.

Referring back to FIG. 7, the ARM7 processor 705 may furthermore be interfaced to an RS232 interface 709 to allow interfacing to the outside world. This serial port may use a Maxim MAX323A interface 709 to convert the processor's 3V signals to RS232 signals. This allows it to communicate with remote hosts for downloading of captured data, uploading of software, programmable parameters, etc. via the externally available connector 708.

The optional RFID reader circuit 704 integrated into one of the two housings may be based on a Philips RC632 ISO15693 RFID reader ASIC. The read coil may be placed around the outside of the glass LCD display 200 in the upper housing. This ASIC 704 may communicate to the ARM7 processor 705 via a simple 4 wire SPI serially clocked data interface, and in an example embodiment it may use an integrated SPI interface on the ARM7 processor 705 for this purpose.

Two typical barcode scanning applications will now be described.

First, a typical barcode scanning data capture stock take application may be implemented by following the steps below:
1. Open the unit by moving it to the first opened position, as shown in FIG. 2, in which the display is visible and the data entry keypad section is open and available.
2. Switch the device on with power on/off switch.
3. The processor resets and starts up.
4. The device displays a prompt on the display, typically requesting a user to scan a barcode.
5. The user may then press the dedicated SCAN button, which is detected by the software running on the ARM processor.
6. The processor may then activate the barcode reader by taking the trigger signal low. The barcode reader starts to emit a scanning laser beam, while its internal circuitry detects any barcode presence. If it detects the presence of a barcode, it scans it, and internally decodes it to provide the actual data via the serial data line to the processor.
7. Once the processor has determined that it has received a barcode, it will continue to scan for a timeout period. If it detects any other barcodes it will reject these, and so only the first barcode will be used.
8. Once the barcode is received, the user may be prompted to enter suitable data. In this example, the user may be prompted to enter the quantity. The numeric quantity may be entered, followed by an ENTER key. Once this is done, a confirmation message may be displayed on the screen.
9. At the same time, a record comprising the specific barcode and the quantity is written to the flash memory in a batch mode. This may then later be uploaded to a host computer once the host computer is interfaced via the RS232 cable.

Second, a typical item by item barcode scanning data capture stock take application may follow the steps below, in which, in this example, no quantities or other data needs to be entered by a user:
1. Open the unit by moving it to its second closed position, as shown in FIG. 3, by opening the unit, and rotating the top housing over completely, and then closing the unit again with the display facing upwards.
2. Switch unit on with power on/off switch.
3. The processor resets and starts up.
4. The device displays a prompt, typically to scan a barcode.
5. The user may then press the dedicated SCAN button, which is detected by the software running on the ARM processor.
6. The processor then activates the barcode reader by taking the trigger signal low. The barcode reader starts to emit a scanning laser beam, while its internal circuitry detects any barcode presence. If it detects the presence of a barcode, it scans it, and internally decodes it to provide the actual data via the serial data line to the processor.
7. Once the processor has determined that it has received a barcode, it will continue to scan for a timeout period. If it detects any other barcodes it will reject these, so that only the first barcode will be used.
8. At the same time, a record comprising the specific barcode is written to the flash memory in a batch mode. This may then later be uploaded to a host computer once the host computer is interfaced via the RS232 cable.

The disclosed invention thus addresses the need to provide a compact data capturing device that includes all the required scanning and processing capabilities by packaging the complete device into two separate housings that are tightly mechanically and electrically connected.

It is understood that the embodiments described hereinabove are merely illustrative and are not intended to limit the scope of the invention. It is realized that various changes, alterations, rearrangements and modifications can be made by those skilled in the art without substantially departing from the spirit and scope of the present invention.

I claim:

1. A portable data capturing device includes:
an upper housing including a display on one side thereof and a lower housing, the housings being mechanically connected together with a hinge arrangement in such a way so as to allow the two housings to be moved between an open position and first and second closed positions, wherein in the first closed position the display is not visible to a user of the device but in the second closed position the display is visible to a user of the device;
a flexible electrical signal connection extending between the two separate housings;
processing means with program and data storage memory;
a keypad;
a barcode reader;
at least one battery to power the device; and
a communications interface to allow the device to communicate with another device.

2. A device according to claim 1 wherein each of the processing means, display, keypad, barcode reader, at least one battery and the communications interface are located in one of the two housings.

3. A device according to claim 1 wherein the device includes an RFID reader integrated into one of the two housings.

4. A device according to claim 1 wherein the keypad is located on the lower housing and wherein when the housings are in either of the closed positions the keypad is covered by the upper housing.

5. A device according to claim 1 further including a plurality of function keys located on the lower housing and wherein when the housings are in either of the closed positions the function keys are not covered by the upper housing.

6. A device according to claim 1 wherein the upper housing can rotate about a first axis from the first closed position into the open position and wherein when in the open position the upper housing can be rotated about a second axis with respect to the lower housing thereby changing the direction that the display faces, and wherein the upper housing can then be rotated about the first axis into the second closed position.
